(19) United States
(12) Patent Application Publication
(10) Pub. No.: US 2016/0082650 A1
(43) Pub. Date: Mar. 24, 2016

(54) REINFORCED THERMOPLASTIC STRUCTURAL COMPONENT AND PROCESS TO MAKE THE SAME

(71) Applicants: William V., CARSON, JR., Bay Village, OH (US); CUTTING DYNAMICS, INC., Avon, OH (US)

(72) Inventor: William V. CARSON Jr., Bay Village, OH (US)

(73) Assignee: Cutting Dynamics, Inc., Avon, OH (US)

(21) Appl. No.: 14/890,435

(22) PCT Filed: May 20, 2014
(86) PCT No.: PCT/US14/38812

§ 371 Date: Nov. 11, 2015

Related U.S. Application Data
(60) Provisional application No. 61/825,844, filed on May 21, 2013.

(51) Int. Cl. B29C 65/48; B29C 65/00; B29C 65/02

(52) U.S. Cl. CPC B29C 65/48; B29C 65/02; B29C 66/1122; B29C 66/73715; B29C 66/7392; B29C 66/929; B29C 66/949; B29L 2031/3076

(57) ABSTRACT

This specification discloses an article of manufacture and a process to make the same. The article of manufacture has a continuous thermoplastic matrix material and a thermoset matrix material comprised of oriented fibers. The thermoset matrix material is bonded to the thermoplastic matrix material at a bonded interface. The article of manufacture can take any number of forms for use in industries such as aircraft, automobiles, motorcycles, bicycles, trains or watercraft.

### CROSS REFERENCES AND PRIORITIES

This application claims priority from U.S. Provisional Application No. 61/825,844 filed on 21 May 2013 the teachings of which are incorporated herein by reference.

### BACKGROUND

Replacing metal and heavy parts with plastic parts is common. However, when the part takes on odd shapes, such as an airplane seat back frame as disclosed in International Patent Publication No. WO 2010/111700, or needs structural strength replacement with plastic becomes more difficult. The use of fibers to reinforce the plastic is a common practice, with oriented fibers known to be stronger than unoriented fibers.

Many have tried to make structural components and parts using thermoset composites reinforced with fibers. Thermoset composites are time consuming to process with low throughput and increased costs. Efforts to decrease the time have resulted in increased weight of the final part, making it unappealing to industries such as the airline industry where increased weight is highly undesirable. Themoplastic composites are less time consuming, but often fail to provide the structural strength necessary for applications such as airplane seat backs.

There exists, therefore, the need for a thermoplastic or thermoset structural component having increased strength and decreased weight which can be produced in a shorter amount of time at less cost.

### SUMMARY

Disclosed herein is an article of manufacture comprising a continuous thermoplastic matrix material, and a continuous thermoset matrix material comprising oriented fibers therein, wherein there is a bonded interface between the continuous thermoplastic matrix material and the thermoset matrix material.

In one embodiment, the continuous thermoplastic matrix material comprises a randomly dispersed filler within the thermoplastic matrix. In one embodiment the randomly dispersed filler is selected from the group consisting of chopped glass fibers and chopped carbon fibers.

In one embodiment, the article of manufacture further comprises an adhesive and at least a portion of the bonded interface comprises an adhesive bond of the adhesive. In another embodiment at least a portion of the bonded interface is a bond selected from the group consisting of a cured bond, a melt bond, a solvent bond, a weld bond and combinations thereof.

In one embodiment, the continuous thermoplastic matrix material is in the form of a molded part. In another embodiment, the continuous thermoplastic matrix material is a thermoplastic longitudinal section. In another embodiment the thermoplastic longitudinal section has a longitudinal length and the longitudinal length is hollow.

In one embodiment, the thermoset matrix material is a thermoset prepreg comprising an un-cured or partially cured thermoset matrix.

In one embodiment, the oriented fibers are selected from the group consisting of oriented glass fibers and oriented carbon fibers.

In one embodiment, the thermoset matrix material is wrapped at least one time around the thermoplastic longitudinal section. In another embodiment the thermoset matrix material is not wrapped around the thermoplastic longitudinal section.

Also disclosed herein is a process for the production of an article of manufacture comprising the steps of:
A) adjoining a continuous thermoplastic matrix material with a thermoset matrix material at an unbonded interface between the continuous thermoplastic matrix material and the thermoset matrix material,
B) creating a bonded interface between the continuous thermoplastic matrix material and the thermoset matrix material.

In one embodiment of the process, the bonded interface is at least partially created by way of an adhesive bond. In another embodiment of the process, the bonded interface is at least partially created by a bond selected from the group consisting of a cured bond, a melt bond, a solvent bond, a weld bond and combinations thereof.

In one embodiment of the process, the continuous thermoplastic matrix material comprises at least one randomly dispersed filler. In another embodiment of the process, the randomly dispersed filler is selected from the group consisting of chopped glass fibers and chopped carbon fibers.

In one embodiment of the process, the thermoset matrix material comprises a plurality of oriented fibers selected from the group consisting of oriented glass fibers and oriented carbon fibers.

In one embodiment of the process, the continuous thermoplastic matrix material and the thermoset matrix material are adjoined by wrapping the thermoset matrix material around the continuous thermoplastic matrix material. In another embodiment of the process, the thermoset matrix material is not adjoined to the continuous thermoplastic matrix material by wrapping the thermoset matrix material around the continuous thermoplastic matrix material.

In one embodiment of the process, the bonded interface is created by heating the adjoined continuous thermoplastic matrix material and the thermoset matrix material at the unbonded interface to a bonding temperature in the range of between 80° C. and 300° C.

In one embodiment of the process, the bonded interface is created by applying a bonding pressure onto the unbounded interface. In one embodiment, the bonding pressure is applied by a clamp on the parts being bonded. In another embodiment, the bonding pressure is applied by a shrink-wrap material which is activated (shrinks) at a temperature less than or equal to the bonding temperature. In another embodiment, the bonding pressure is applied by way of a gas chamber placing pressure on the outer surface of the articles to be bonded.

In one embodiment of the process, the continuous thermoplastic matrix material, the thermoset matrix material, or both the continuous thermoplastic matrix material and the thermoset matrix material are subjected to a surface pretreatment prior to adjoining the continuous thermoplastic matrix material with the thermoset matrix material. In one embodiment, the surface pretreatment is selected from the group consisting of solvent treatment, chemical treatment, plasma treatment, corona treatment, flame treatment and combinations thereof.

In one embodiment of the process, the continuous thermoplastic matrix material is in the form of a molded part.

In one embodiment of the process, the thermoset matrix material originates as a thermoset pre-preg.

### BRIEF DESCRIPTION OF FIGURES

FIG. 1 is a disassembled view of a structural component.

FIG. 2 is a view of an assembled structural component.

FIG. 3 is a cross-section view of a structural component.

FIG. 4 is a disassembled view of a structural component.

FIG. 5 is a view of an assembled structural component.

FIG. 6 is a cross-section view of a structural component.

### DETAILED DESCRIPTION

This specification discloses an article of manufacture as shown in FIG. 2 comprising a continuous thermoplastic matrix material (120). The continuous thermoplastic matrix material may further comprise a randomly dispersed filler therein. The article further comprises thermoset matrix material (110) comprising a plurality of oriented fibers therein wherein there is a bonded interface (130) between the continuous thermoplastic matrix material and the thermoset matrix material.

Also disclosed herein is a process for manufacturing said article.

The article of manufacture and process to manufacture the article relies upon the discovery that a moldable grade of thermoplastic preferably comprising a randomly dispersed filler such as fibers can be structurally reinforced by bonding the thermoplastic with a thermoset matrix material (110) comprising a plurality of oriented fibers, with the resulting article of manufacture having improved strength without a significant increase in weight.

As used herein and in the claims, the term “thermoplastic material” or “thermoplastic matrix” means a plastic material or matrix that has a softening or melting point, and is substantially free of a three dimensional cross linked network resulting from the formation of covalent bonds between chemically reactive groups, e.g., active hydrogen groups and free isocyanate groups, (meaning that less than 5% by weight of the thermoplastic material does not have such bonds known as thermoset bonds). The thermoplastic material may contain a dispersion of ground thermoset plastics, but the continuous matrix phase itself will be substantially free of thermoset bonds.

By continuous, it is meant that the thermoplastic material forms the major phase into which the fillers and additives are dispersed. As a continuous phase, the thermoplastic material is the primary material at the surface of any molded part immediately after molding and before any of the additives have time to rise to the surface or bloom from the matrix over time.

In a preferred embodiment, the continuous thermoplastic matrix material (120) is injection molded into a thermoplastic longitudinal section (100) having a thermoplastic longitudinal section length dimension (101), a thermoplastic longitudinal section width dimension (102) and a thermoplastic longitudinal section height dimension (103). In one embodiment, this thermoplastic longitudinal section comprises a hollow interior (105) running along the longitudinal section length dimension such as in a tube.

Examples of thermoplastic materials from which the continuous thermoplastic matrix material may be selected include, but are not limited to, thermoplastic polyphenylene sulfide, thermoplastic polyetheretherketone, thermoplastic polyetherketoneketone, thermoplastic polyether imide, thermoplastic polyurethane, thermoplastic polyurea, thermoplastic polyimide, thermoplastic polyamide, thermoplastic polyamideimide, thermoplastic polyester, thermoplastic polycarbonate, thermoplastic polysulfone, thermoplastic polyketone, thermoplastic polypropylene, thermoplastic acrylonitrile-butadiene-styrene, thermoplastic polyethersulfone and mixtures or thermoplastic compositions containing one or more and their copolymers thereof.

Of the thermoplastic materials from which the continuous thermoplastic matrix material may be chosen, the thermoplastic polyamides and thermoplastic polysulfones are preferred. The thermoplastic longitudinal section may be fabricated from thermoplastic materials by the art-recognized process of injection molding, in which a molten stream of thermoplastic material, e.g., molten thermoplastic polyamide, is injected into a mold, e.g., an optionally heated mold.

The continuous thermoplastic matrix materials are often reinforced with fillers including those known in the art. These fillers are usually blended (dispersed) into the continuous thermoplastic matrix material during the thermoplastic matrix material's molten state. At this point the filler, which is a plurality of small pieces, is randomly dispersed into the continuous thermoplastic matrix material. Fillers are usually made from substances which do not melt at the melting point of the thermoplastic matrix material, in particular if the filler melts, it melts at a temperature greater than the melting point of the thermoplastic matrix material. The fillers are generally much stronger in tensile properties than the thermoplastic matrix material. These types of fillers may be made of glass, ceramic, metal, expandable microbeads which expand upon heating to create a pseudo foamed structure, carbon, clay, mica, sand, or other minerals. The fillers may be in the shape of beads (round) or have varying aspect ratios such as those associated with fibers and one type of filler is a chopped fiber. Preferred randomly dispersed fillers are fibers selected from the group consisting of glass fibers, carbon fibers, metal fibers, polyamide fibers and mixtures thereof. The plurality of randomly dispersed filler types may be the same type of fiber as those of the oriented fibers in the thermoset matrix material.

In one such embodiment, the randomly dispersed fillers originate as large sheets and are chopped or cut into smaller, randomly dispersed fillers prior to being introduced to the continuous thermoplastic matrix material. In one embodiment the thermoplastic longitudinal section may be void of randomly dispersed fillers, meaning less than 5% of the weight of the thermoplastic longitudinal section is reinforced with randomly dispersed fillers.

As used herein and in the claims the term “thermoset” means plastic materials having a three dimensional cross linked network resulting from the formation of covalent bonds between chemically reactive groups, e.g., active hydrogen groups and free isocyanate groups or oxirane groups. Once the three dimensional cross linked network resulting from the formation of covalent bonds between chemically reactive groups is formed the thermoset is said to have cured. Prior to forming the three dimensional cross linked network resulting from the formation of covalent bonds between chemically reactive groups, the thermoset is said to be un-cured. The uncured thermoset is also known as a pre-preg. While the three dimensional cross linked network resulting from the formation of covalent bonds between chemically reactive groups is in the process of being formed the thermoset is said to be partially cured.

Thermoset plastic materials that may be fabricated include those known to the skilled artisan, e.g., cross linked polyurethanes, cross linked polyepoxides and cross linked polyesters. For purposes of illustration, a thermoset may be fabricated from cross linked polyurethanes by the art-recognized process of reaction injection molding. Reaction injection molding typically involves, as is known to the skilled artisan, injecting separately, and preferably simultaneously, into a mold: (i) an active hydrogen functional component (e.g., a polyol and/or polyamine); and (ii) a functional component that forms covalent bonds with the active hydrogen functional component, such as an isocyanate functional component (e.g., a diisocyanate such as toluene diisocyanate, and/or dimers and trimers of a diisocyanate such as toluene diisocyanate). The filled mold may optionally be heated to ensure and/or hasten complete reaction of the injected components.

The thermoset matrix materials are preferably reinforced with a type of oriented fiber selected from the group consisting of glass fibers, carbon fibers, metal fibers, polyamide fibers and mixtures thereof. Carbon fibers are a preferred oriented fiber in the present invention. The reinforcing fibers, and the glass fibers in particular, may have sizings on their surfaces, or other surface treatment, to improve miscibility and/or adhesion to the thermoset into which they are incorporated, as is known to the skilled artisan.

When used, the oriented fibers, are typically present in the thermoset matrix material in a reinforcing amount, that is preferably in an amount of from 5 percent by weight to 60 percent by weight, based on the total weight of the thermoset matrix material and the oriented fibers.

The carbon fibers used to form the thermoset matrix material may have an average fiber diameter of 4 micrometers to 12 micrometers. One suitable carbon fiber is from Zoltek Corporation of St Louis, Mo. USA, and has the trade name Panex 35. Other suitable carbon fibers are from Hexcel Corporation of Stamford, Conn. USA, and include AS4 carbon fibers and IM7 carbon fibers. The fiber volume fraction may be 0.5 to 0.7 of the thermoset matrix material. In the case of nano-fibers, average diameters of 2 to 12 microns are typical.

To obtain the strength required, the fibers in the thermoset matrix material are preferably continuous fibers and oriented or highly aligned in different parallel planes of the thermoset matrix material. The oriented fiber in a ply may also be woven with fibers in the ply so that many fibers are aligned in a first direction, the other fibers are aligned in a direction different from the first direction, but in the same direction considered a second direction, passing over and under the fibers aligned in the first direction and are thus woven with the fibers aligned in the first direction.

In one embodiment, the thermoset matrix material originates as a thermoset prepreg (112) comprised of oriented fibers in an uncured or partially cured thermoset. A thermoset prepreg may be prepared by passing the fibers through a formulated resin bath and heat treating to evaporate the solvent and partially cure the thermoset. After forming the partially cured thermoset prepreg to the desired shape, the structure is cured at high temperature (100-300° C.) and pressure for 30-90 minutes. Kirk-Othmer Encyclopedia of Chemical Technology, 5^{th} ed., Volume 10, page 454, 2005, John Wiley & Sons Inc., Hoboken, N.J.

Where the thermoset matrix material originates as a prepreg comprised of oriented fibers, the oriented fibers are highly aligned in parallel planes. The oriented fibers may also be woven. The oriented fibers may be in an amount of thermoset, which has not yet been cured, or has only been partially cured. The prepreg comprised of oriented fibers is therefore malleable and can easily be wrapped around or formed over the continuous thermoplastic matrix material (120). In a preferred embodiment the prepreg comprised of oriented fibers is in the form of a prepreg tape (115). One such prepreg tape is AX-5180 available from Axiom Materials, Inc., Santa Ana, Calif., United States.

Where the thermoset matrix material originates as a prepreg tape (115) having woven fiber plies, the prepreg tape may have a thickness of less than 1 mm with less than 0.5 mm being more preferred and less than 0.3 mm being most preferred. The advantage to thermoset tapes is that, due to the thickness of the thermoset tape, one layer of thermoset tape can be used to reinforce a thermoplastic longitudinal section without substantially increasing the weight of the finished product. In cases where additional strength is required beyond that provided by a single layer of thermoset tape multiple layers of thermoset tape can be utilized to reinforce the thermoplastic longitudinal section without substantially increasing the weight of the finished product. Where multiple layers of thermoset tape are utilized, the outer layer or outer layers of thermoset tape may partially or fully overlap the inner layer or inner layers of thermoset tape.

One of ordinary skill will recognize that the article can be made by adjoining the continuous thermoplastic matrix material (120) and the thermoset matrix material (110) to create an unbonded interface between the thermoset matrix material and the continuous thermoplastic matrix material and then bonding the thermoset matrix material with the continuous thermoplastic matrix material.

In one embodiment, the unbonded interface between the thermoset matrix material (110) and the continuous thermoplastic matrix material (120) may be such that there is direct physical contact between the thermoset matrix material and the continuous thermoplastic matrix material.

In another embodiment the unbonded interface between the thermoset matrix material (110) and the continuous thermoplastic matrix material (120) may be such that there is no direct physical contact between the thermoset matrix material and the continuous thermoplastic matrix material. For example, there may be an adhesive applied between the thermoset matrix material and the continuous thermoplastic matrix material. In this manner, the continuous thermoplastic matrix material and the thermoset matrix material are both in direct contact with the adhesive, but the thermoset matrix material is not in direct contact with the continuous thermoplastic matrix material. In one embodiment the adhesive may be a curable adhesive. It should be noted that, in such an embodiment, until the adhesive is allowed to dry and cure, the continuous thermoplastic matrix material and the thermoset matrix material are not considered to be bonded and, thus, the interface between the continuous thermoplastic matrix material and the thermoset matrix material is still considered an unbonded interface.

In still a further embodiment, the unbonded interface between the thermoset matrix material (110) and the continuous thermoplastic matrix material (120) may be such that a first portion of the thermoset matrix material is in direct physical contact with the continuous thermoplastic matrix material, while a second portion of the thermoset matrix material is not in direct physical contact with the continuous thermoplastic matrix material. For example, one or more parts of the thermoset matrix material may be in direct contact with the continuous thermoplastic matrix material while one or more parts of the thermoset matrix material have an adhesive layer between them and the continuous thermoplastic matrix material.

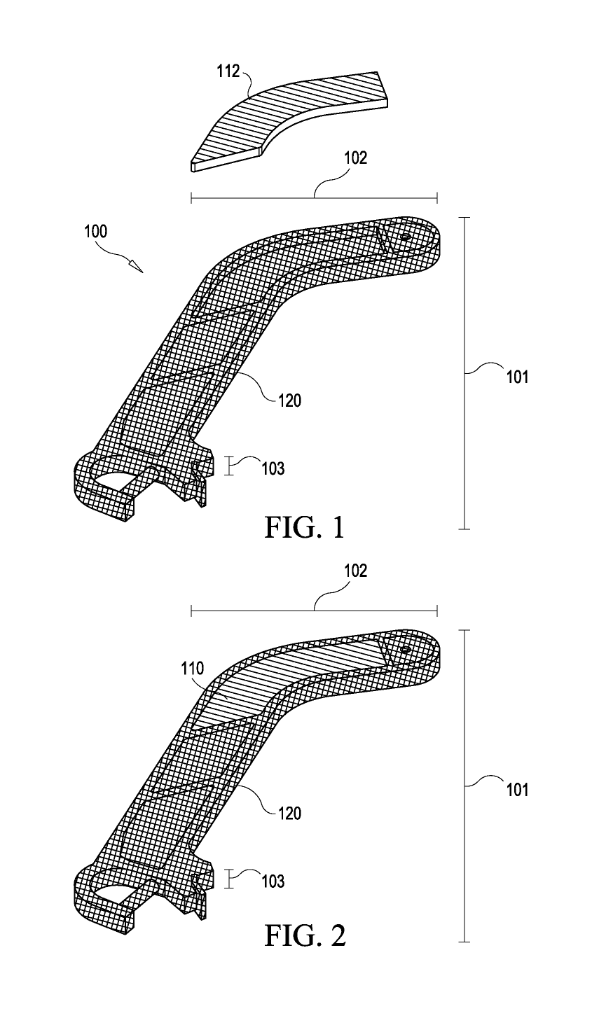

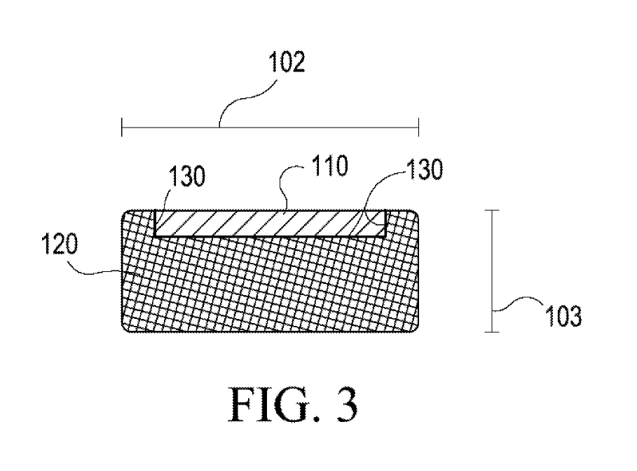

In one embodiment, the thermoset matrix material (110) can be cut to size as depicted in FIG. 1 and adjoined to the continuous thermoplastic matrix material (120) without wrapping the thermoset matrix material around the continuous thermoplastic matrix material as seen in FIG. 2. In a further embodiment, there may be more than one thermoset matrix material, each of which is cut to size and adjoined to the continuous thermoplastic matrix material without wrapping any of the multiple thermoset matrix materials around the continuous thermoplastic matrix material. FIG. 3 depicts a cross-sectional view of a thermoset matrix material adjoined to the continuous thermoplastic matrix material without wrapping.

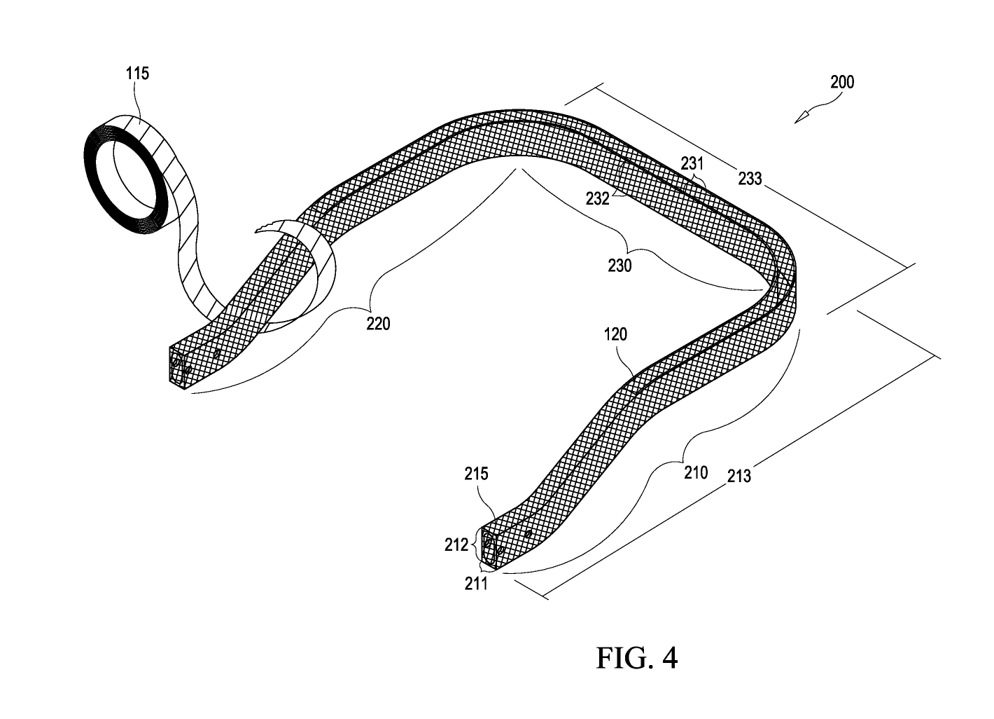

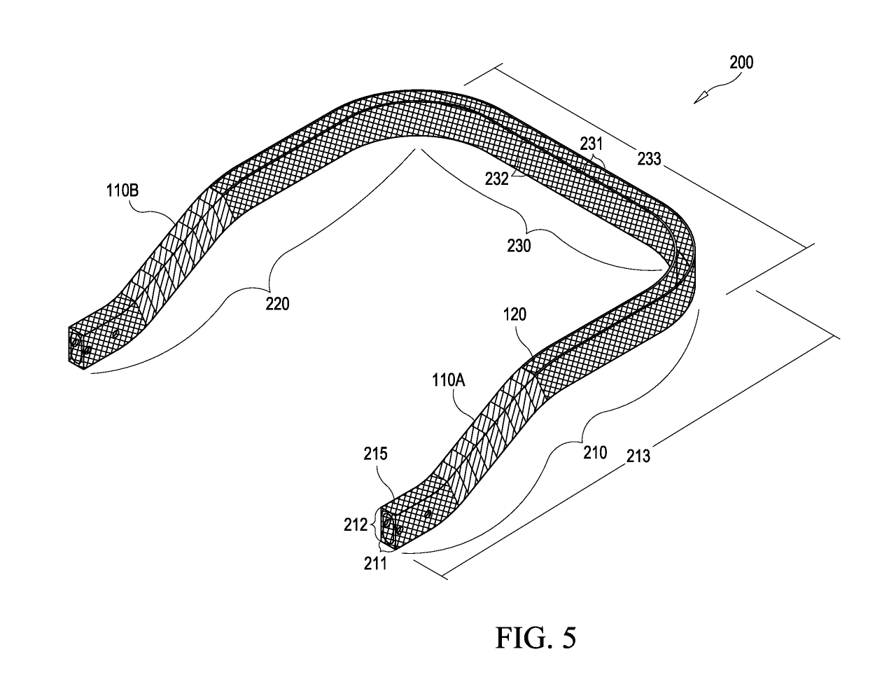

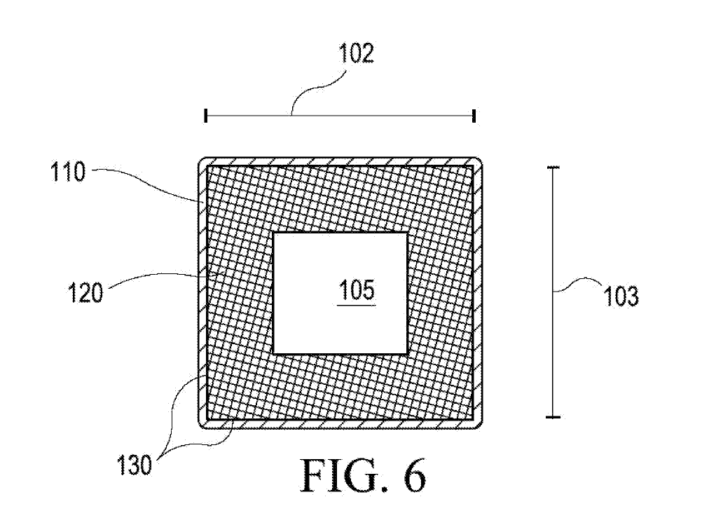

In another embodiment the thermoset matrix material (110) can be adjoined to the continuous thermoplastic matrix material (120) by wrapping the themoset matrix material around the continuous thermoplastic matrix material as seen in FIG. 4. Where the thermoset matrix material is wrapped around the continuous thermoplastic matrix material, the thermoset matrix material is adjoined to the continuous thermoplastic matrix material along the entirety of the longitudinal section width dimension (102) and the entirety of the longitudinal section height dimension (103) as shown in FIG. 6. The thermoset matrix material may be wrapped around the entirety of the longitudinal section length dimension (101) or only a portion of the longitudinal section length dimension as shown in FIG. 5.

It has been discovered that it is preferable to have a bonded interface (130) between the thermoset matrix material (110) and the continuous thermoplastic matrix material (120). Preferably, the bonded interface is such that, when subjected to a peel test, the thermoset matrix material and/or the continuous thermoplastic matrix material will fracture while the bonded interface remains intact. A peel test requires that the thermoset matrix material is securely held in one clamp while the thermoplastic matrix material is securely held in a second clamp. An increasing force is applied to the thermoset matrix material in a direction perpendicular to the bonded interface, while at the same time an increasing force is applied to the thermoplastic matrix material the direction opposite of the force that is applied to the thermoset matrix material. If the bonded interface is sufficiently bonded, the thermoset matrix material and/or the continuous thermoplastic matrix material will fracture while the bonded interface remains intact. The bonded interface may be selected from the group of bonds consisting of an adhesive bond, a cured bond, a melt bond, a solvent bond, a weld bond and combinations thereof.

The bonded interface (130) can be accomplished in a variety of ways. In one embodiment, the bonded interface is an adhesive bond wherein an adhesive binds the continuous thermoplastic matrix material (120) with the thermoset matrix material (110). The adhesive may or may not be a curable adhesive. The adhesive may be applied to the thermoset matrix material (110), the continuous thermoplastic matrix material or both the thermoset matrix material and the continuous thermoplastic matrix material. Although it is believed that any adhesive may be utilized, multi-part reactive adhesives are preferred. Of the multi-part reactive adhesives, Scotch-Weld™ 7246-2 B/A FST adhesive available from The 3M Company, St. Paul, Minn., United States is preferred. Reactive adhesives are curable adhesive.

When the thermoplastic matrix material originates as a prepreg (112) or a prepreg tape (115), the adhesive may already be present in the prepreg or prepreg tape. In this instance, all that is required is to apply the prepreg or prepreg tape to the continuous thermoplastic matrix material (120) and allow the thermoset matrix material to cure.

In an alternative embodiment, the bonded interface (130) is a melt bond wherein the thermoset matrix material (110) is bonded to the continuous thermoplastic matrix material (120) by applying a bonding pressure to the unbonded interface between the continuous thermoplastic matrix material and the thermoset matrix material, heating the continuous thermoplastic matrix material and the thermoset matrix material to a bonding temperature and maintaining the thermoplastic matrix material and the thermoset matrix material at the bonding temperature and bonding pressure for a bonding time until the interface between the continuous thermoplastic matrix material and the thermoset matrix material is co-mingled.

In another alternative embodiment, the bonded interface (130) is a solvent bond wherein a solvent is applied to the surface of both the continuous thermoplastic matrix material (120) and the thermoset matrix material (110) in order to soften the surface of the continuous thermoplastic matrix material and the thermoset matrix material. When pressure is applied to the interface between the thermoplastic matrix material and the thermoset matrix material, and the solvent is evaporated, the remaining materials will have been bonded.

In yet another alternative embodiment, the bonded interface (130) is a weld bond wherein a molten polymer is applied at the unbonded interface between the continuous thermoplastic matrix material (120) and the thermoset matrix material (110). As the molten polymer cools and hardens it bonds the thermoset matrix material and the continuous thermoplastic matrix material to form the bonded interface.

One of ordinary skill will recognize that the bonded interface can be created by any combination of an adhesive bond, a melt bond, a solvent bond and/or a weld bond.

Creating a bonded interface (130) between the continuous thermoplastic matrix material and the thermoset matrix material may be assisted by, or may even require, a bonding pressure above atmospheric pressure at the unbonded interface between the thermoset matrix material and the continuous thermoplastic matrix material. Minimum pressure can be maintained by any number of devices. In one embodiment, a clamp is used to maintain a minimum pressure between the thermoset matrix material and the continuous thermoplastic matrix material. A clamp is a mechanical tool used to secure two or more objects together. By way of example, but not limitation, typical clamps that may be used include C clamps, band clamps, bar clamps, hose clamps, pipe clamps and marman clamps.

In another embodiment, minimum pressure is maintained by wrapping a shrink-wrap material around the thermoset matrix material (110) which has been adjoined to the continuous thermoplastic matrix material (120). A shrink-wrap material is a polymer film that is wrapped around the thermoset matrix material (the thermoset matrix material having an unbonded interface with the continuous thermoplastic matrix material). When heat is applied, the shrink-wrap material activates and shrinks tightly to the thermoset matrix material adjoined to the continuous thermoplastic matrix material, thereby applying the bonding pressure. In a preferred embodiment the shrink-wrap material activates at a temperature less than or equal to the bonding temperature. Common shrink-wrap materials include polyolefin shrink-wraps and poly-vinyl chloride shrink-wraps. One preferred shrink-wrap material is HI-SHRINK TAPE available from Dunstone Company, Inc., Charlotte, N.C., USA. When using a shrink-wrap material the bonding pressure may be at least 15 psig, with at least 30 psig being more preferred and at least 45 psig being even more preferred. The maximum amount of bonding pressure is not considered important, but may be as much as 150 psig, with as much as 125 psig being more preferred and as much as 100 psig being even more preferred.

In still another embodiment minimum pressure is maintained using gas pressure from a gas chamber, such as steam pressure as found in an autoclave. In such an embodiment, the thermoset matrix material adjoined to the thermoplastic matrix material is inserted into a pressure vessel which is filled with saturated steam, or other gas to pressurize the vessel. Pressure is maintained in the range of between 1 bar and 2 bar at a temperature between 100° C. and 150° C., with 100° C. to 300° C. most preferred.

The minimum pressure, or bonding pressure, is generally 1 bar or greater.

Where the bonded interface (130) is an adhesive bond, creating the bonded interface may require that the continuous thermoplastic matrix material (120) and the thermoset matrix material (110) be heated to a bonding temperature. Depending upon the adhesive used, the bonding temperature may be as low as room temperatures (25° C.) or as high as 180° C., or even 300° C. Preferably, the bonding temperature is in the range of between 120° C. and 300° C. with 120° C. to 250° C. also preferred. Where the adhesive is a curable adhesive, the bonding temperature must be maintained, along with the bonding pressure, for a bonding time sufficient to allow the adhesive to cure such that the thermoset matrix material (110) and the continuous thermoplastic matrix material (120) become bonded. Preferably the bonding time is between 1 hours and 48 hours with a bonding time between 1 hours and 24 hours being more preferred, a bonding time between 1 hours and 16 hours being even more preferred and a bonding time between 1 hours and 8 hours being most preferred.

Where at least a portion of the bonded interface (130) is a melt bond, creating the bonded interface requires that the continuous thermoplastic matrix material (120) and the thermoset matrix material (110) be heated to a bonding temperature. The bonding temperature is preferably above the vicat softening point of the thermoset matrix material and the continuous thermoplastic matrix material. The bonding temperature must be maintained, along with the bonding pressure, for a bonding time sufficient to allow the continuous thermoplastic matrix material to become co-mingled with the thermoset matrix material such that the continuous thermoplastic matrix material and the thermoset matrix material are melt bonded. The pressure is used to generate at least part of the heat, if not generate all of the heat at the interface, like packing a snowball.

It should be pointed out, that in the above embodiments, the thermoset matrix material is bonded to an exterior surface of the continuous thermoplastic matrix and not an interior surface, such as inside a hollow portion of a tube of continuous thermoplastic matrix.

In one embodiment it may be beneficial, or even necessary to treat the surface of the continuous thermoplastic matrix material (120), the thermoset matrix material (110) or both the continuous thermoplastic matrix material and the thermoset matrix material in order to make the continuous thermoplastic matrix material and/or the thermoset matrix material more bondable. Preferred surface treatments include solvent treatment, chemical treatment, plasma treatment, corona treating or flame treating. The best results are expected when the surface treatment is a plasma treatment. The preferred plasma treatment is conducted using a Surfx Atomflo Atmospheric Plasma System available from Surfx Technologies of Redondo Beach, Calif., USA. Preferably the plasma treatment is conducted for a time of less than 4 hours, with less than 3 hours being more preferred, and less than 2 hours being even more preferred. Surface treatment of the continuous thermoplastic matrix material and/or the thermoset matrix material may be used with or without an adhesive between the thermoset matrix material and the continuous thermoplastic matrix material.

While the structure of the article of manufacture may have numerous configurations or shapes, in one embodiment, depicted in FIG. 5, the present invention is an airplane composite seat back frame (200) having a first leg section (210), a second leg section (220) and a top section (230) where at least a portion of the first leg section and the second leg section comprises, a channel having a base or bottom and side walls, each having interior surfaces which define a hollow interior such as in a tube (105).

Where the article of manufacture is formed into an airplane composite seat back frame (200) the thermoplastic longitudinal section will have a first leg section (210), a second leg section (220) and a top section (230). This general structure can be seen in FIG. 4 where 200 denotes the composite seat back frame. The first leg section will have a first leg section length dimension (213), a first leg section width dimension (211), and a first leg section height dimension (212). The length dimension will be the longest dimension and is aligned with the direction of the spine of a person sitting in the seat. The width dimension is the dimension traveling perpendicular to the length dimension, lying in the “U” structure horizontal plane defined by the first leg section, the second leg section and the top section which connects or joins the first and second leg sections. The first and second leg section horizontal dimensions are perpendicular to the “U” structure horizontal plane.

The top section (230) could be a straight piece or a curved piece that transitions from the second end of the first leg section, running in the “U” structure horizontal plane and then transitions into the second end of the second leg section.

It is preferred that the continuous thermoplastic matrix material of the first leg section (210), the second leg section (220) and the top section (230) are all one single, molded, extruded or formed part. In this instance, the continuous thermoplastic matrix material of the first leg section, the second leg section and the top section are all comprised of the same thermoplastic matrix.

For clarity, the first leg section (210) further will have a first leg section first end (215). The second leg section (220) is usually of similar, or even like dimensional design as the first leg section. The second leg section will have a second leg section length dimension, a second leg section width dimension, a second leg section height dimension, wherein the second leg section length is the longest dimension of the second leg section, the second leg section further having a second leg section first end.

As mentioned earlier, the top section (230) will have a top section length dimension (233), a top section width dimension (231), a top section height dimension (232), with the top section connected to the first leg section second end and the second leg section second end in a “U” structure having a “U” structure horizontal plane defined by the first leg section, the second leg section. Thus the first and second leg section, lie in the “U” structure horizontal plane.

The first leg section (210) and second leg section (220) will each have at least one stress location defined respectively as the first leg section stress location and the second leg section stress location. The stress location of the respective leg depends upon the leg design and how the leg is locked or permanently fixed. The stress location is the point where the leg without the thermoset matrix material structurally fails when an increasing force is applied to the top section (230) when the first and second leg sections are fixed so they do not move. Structurally fails means that the leg is permanently distorted from its original shape, which is usually observed as a kink, a collapse, or the propagation of a crack. In general, the thermoset matrix material (110) should be bonded to the appropriate leg and located at the leg stress location.

The increasing force is applied perpendicular to the “U” shaped member horizontal plane. In a preferred embodiment, the legs are made of the same design and same dimensions and materials, so a force applied at the middle of the top section (230) should cause both legs to fail at the same time in substantially the same place. However, this is often not the case, and the force can be varied at different points along the top section to cause the leg of interest to fail before the other leg. Should a leg not fail, then its stress location is at the leg end furthest from the top section.

In one embodiment where the article of manufacture is an airplane composite seat back frame (200), the airplane composite seat back frame can have one or more thermoset matrix materials as shown in FIG. 5. The first leg section (210) will have a first leg section thermoset matrix material (110A) wrapped around and bonded to the first leg section outside the first leg section and located at the first leg section stress location. By locating the first leg section thermoset matrix material at the first leg stress location and bonding it to the first leg section outside the first leg section, the first leg section thermoset matrix material reinforces the first leg, providing increased strength at the first leg stress location.

Most likely there will be a second leg section thermoset matrix material (110B) wrapped around and bonded to the second leg section (220) outside the second leg section and located at the second leg section stress location. By locating the second leg section thermoset matrix material at the second leg stress location and bonding it to the second leg section outside the second leg section, the second leg section thermoset matrix material reinforces the second leg, providing increased strength at the second leg stress location.

In an alternative embodiment the first leg section (210) will have a first leg section thermoset matrix material overlaid onto (not wrapped around) and bonded to the first leg section outside the first leg section and located at the first leg section stress location. The second leg section thermoset matrix material, if present, may also be overlaid onto (not wrapped around) and bonded to the second leg section outside the second leg section and located at the second leg section stress location.

The first leg section thermoset matrix material (110A) may originate as a prepreg tape (115) comprised of oriented fibers and the second leg section thermoset matrix material (110B) may originate as a prepreg tape (115) comprised of oriented fibers. In a preferred embodiment the first leg section thermoset matrix material and the second leg section thermoset matrix material are made from the same thermoset matrix and the same type of oriented fibers.

One of ordinary skill will recognize that there may be more than one first leg stress locations and/or more than one second leg stress locations. For instance, the first leg may have a first leg first stress location and a first leg second stress location. In this instance the first leg will have a first leg first thermoset matrix material bonded to and located at the first leg first stress location and a first leg second thermoset matrix material bonded to and located at the first leg second stress location.

It should be clear to one of ordinary skill how using the much stronger directionally oriented fibers of the thermoset matrix material placed at and over areas of stress locations and bonded to a thermoplastic longitudinal section (100) allows for an injection molded structural component that is made quickly. The invention is not limited to the embodiments disclosed but to all equivalents using the principles taught herein.

Because this invention may use thermoplastics that are inherently flame retardant, the use of additional flame retardants is not considered necessary. Thus, the article of this invention is halogen free, meaning that the total amount of halogens which are not present as catalyst for the thermoplastic material, is less than 1% by weight of the total composition halogens. The amount of halogen is the amount of material as halogen, not the amount of Halogen compound.

### Example 1

The inventors created an airplane seat frame by molding a “U” shaped thermoplastic longitudinal section comprised of chopped carbon fibers in a thermoplastic polyphenylene sulfide matrix. The surface of the thermoplastic longitudinal section was subjected to plasma treatment using a Surfx Atomflo Atmospheric Plasma System and wrapped in Axiom AX-5180 prepreg tape. The wrapped thermoplastic longitudinal section was then wrapped in HI-SHRINK TAPE and placed in an oven at 250° C. for 4 hours.

When the thermoplastic longitudinal section was removed from the oven and allowed to cool to room temperature it was visually observed that a bond had formed between the Axiom AX-5180 prepreg tape and the thermoplastic longitudinal section.

Although particular embodiments of the invention have been described herein, it will be understood that the invention is not limited correspondingly in scope, but includes all changes and modifications coming within the spirit and terms of claims appended hereto. Particularly, the current invention is not limited to an airplane composite seat back frame, but encompasses any structural component which can be made of thermoplastic materials requiring lighter weight and increased strength.

We claim:

1-32. (canceled)

33. A process for the production of an article of manufacture comprising the steps of:
A) adjoining a continuous thermoplastic matrix material with a thermoset matrix material at an unbonded interface between the continuous thermoplastic matrix material and the thermoset matrix material, and
B) creating a bonded interface between the continuous thermoplastic matrix material and the thermoset matrix material
wherein the continuous thermoplastic matrix material, the thermoset matrix material, or both the continuous thermoplastic matrix material and the thermoset matrix material are subjected to a surface pretreatment selected from the group consisting of solvent treatment, chemical treatment, plasma treatment, corona treatment, flame treatment and combinations thereof prior to adjoining the continuous thermoplastic matrix material with the thermoset matrix material, and creating the bonded interface is done at least in part by applying a bonding pressure to the unbonded interface.

34. The process of claim 33, wherein the bonded interface is at least partially created by way of an adhesive bond.

35. The process of claim 33, wherein the bonded interface is at least partially created by a bond selected from the group consisting of a cured bond, a melt bond, a solvent bond, a weld bond and combinations thereof.

36. The process of claim 33, wherein the continuous thermoplastic matrix material comprises at least one randomly dispersed filler selected from the group consisting of chopped glass fibers and chopped carbon fibers.

37. The process of claim 33, wherein the thermoset matrix material comprises a plurality of oriented fibers selected from the group consisting of oriented glass fibers and oriented carbon fibers.

38. The process of claim 36, wherein the thermoset matrix material comprises a plurality of oriented fibers selected from the group consisting of oriented glass fibers and oriented carbon fibers.

39. The process of claim 33, wherein the continuous thermoplastic matrix material and the thermoset matrix material are adjoined by wrapping the thermoset matrix material around the continuous thermoplastic matrix material.

40. The process of claim 37, wherein the continuous thermoplastic matrix material and the thermoset matrix material are adjoined by wrapping the thermoset matrix material around the continuous thermoplastic matrix material.

41. The process of claim 38, wherein the continuous thermoplastic matrix material and the thermoset matrix material are adjoined by wrapping the thermoset matrix material around the continuous thermoplastic matrix material.

42. The process of claim 33, wherein the thermoset matrix material is not adjoined to the continuous thermoplastic matrix material by wrapping the thermoset matrix material around the continuous thermoplastic matrix material.

43. The process of claim 37, wherein the thermoset matrix material is not adjoined to the continuous thermoplastic matrix material by wrapping the thermoset matrix material around the continuous thermoplastic matrix material.

44. The process of claim 38, wherein the thermoset matrix material is not adjoined to the continuous thermoplastic matrix material by wrapping the thermoset matrix material around the continuous thermoplastic matrix material.

45. The process of claim 33, wherein creating the bonded interface is done at least in part by heating the adjoined continuous thermoplastic matrix material and the thermoset matrix material at the unbonded interface to a bonding temperature in the range of between 80° C. and 300° C.

46. The process of claim 33, wherein the bonding pressure is applied by a clamp.

47. The process of claim 33, wherein the bonding pressure is applied by a shrink-wrap material which is activated at a bonding pressure to the unbonded interface.

48. The process of claim 33, wherein the bonding pressure is applied by way of a gas chamber.

49. The process of claim 33, wherein the continuous thermoplastic matrix material is in the form of a molded part.

50. The process of claim 33, wherein the thermoset matrix material originates as a thermoset pre-preg.

51. The process of claim 33, wherein creating the bonded interface is done at least in part by heating the adjoined continuous thermoplastic matrix material and the thermoset matrix material at the unbonded interface for a bonding time in the range of between 1 hours and 48 hours.
